(19) United States
(12) Patent Application Publication
(10) Pub. No.: US 2026/0105000 A1
(43) Pub. Date: Apr. 16, 2026

(54) MODEL AND QUERY SERVER FOR LOCAL INFERENCING AND TRAINING WITH GENERATIVE MODELS

(71) Applicant: Dell Products L.P., Round Rock, TX (US)

(72) Inventors: Diego Vrague Noble, Pelotas (BR); Randall H. Shain, Wrentham, MA (US); Qing Ye, Hopkinton, MA (US); Paulo de Figueiredo Pires, Niterói (BR)

(21) Appl. No.: 18/916,959

(22) Filed: Oct. 16, 2024

(51) Int. Cl. G06F 12/0802; G06N 5/04

(52) U.S. Cl. CPC G06F 12/0802; G06N 5/04; G06F 2212/60

(57) ABSTRACT

A model and query system for local inferencing and/or training. A model and query server (MQS) includes a model manager and a cache manager. The model manager is configured to manage deployment of models to clients in the local network, execute queries at the server, control models cached, and manage workload execution. The cache manager is configured to manage a cache of models. The model and query system is configured to orchestrate or manage query execution, which includes inferencing operations, at a local level.

### TECHNOLOGICAL FIELD OF THE DISCLOSURE

Embodiments disclosed herein generally relate to a localized model and query system/server. More particularly, at least some embodiments relate to systems, hardware, software, computer-readable media, and methods for orchestrating localized inferencing and training in clients.

### BACKGROUND

Generative artificial intelligence (GenAI) is currently receiving a lot attention. Significant advances have been made in various types of generative models, including large language models. However, generative models typically execute at a location that is remote from the source of the demand or data generation.

Attempts to move models closer to the source of the demand or data generation includes artificial intelligence personal computer (AI PC), which is a new technology that is largely undefined. However, the central goal of AI PC is to locally run lighter workloads that have generative AI aspects.

Even if an AI PC includes sufficient hardware capabilities (e.g., accelerators, memory, storage) to run GenAI workloads locally, the AI PC still need additional components. These components include deep learning computational models for inference and the data and documents required to respond to workload demands and queries.

The lack of these components presents a variety of challenges. For example, acquiring these types of models and the necessary data and document presents various issues. Deep learning models can consume a significant amount of storage and network resources and need to be downloaded from the Internet. This issue becomes more pronounced as the need for smaller, specialized models that need to be locally available increases. Furthermore, employing multiple GenAI-based agents or copilots on an AI PC may exacerbate this situation as these agents and copilots may also require access to various types of models.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a model and query server that includes a model manager and a cache manager deployed in a computing environment;

FIG. 2 discloses aspects of a model manager operating in a particular mode;

FIG. 3 discloses aspects of a method for locally orchestrating a query by a model and query server;

FIG. 4 discloses aspects of policy-driven operations or actions performed by a cache manager;

FIG. 5 discloses aspects of cache management performed by a cache manager;

FIG. 6 discloses an example of model and query servers deployed to and operating in localized environments or networks; and

FIG. 7 discloses aspects of a computing device, system, or entity.

### DETAILED DESCRIPTION OF SOME EXAMPLE EMBODIMENTS

Embodiments disclosed herein generally relate to a centralized system for orchestrating models in a local network or a model and query system. More particularly, at least some embodiments relate to systems, hardware, software, computer-readable media, and methods for performing model inferencing, training, and/or orchestration locally.

Generative artificial intelligence (GenAI or generative models) is a form of Artificial Intelligence that is capable of generating data from previously observed patterns in large datasets. This technology continues to advance with the increasing availability of more powerful deep learning (DL) models. Examples of generative models include Generative Adversarial Networks (GANs), Generative Pre-trained Transformers (GPTs), Generative Diffusion Models (GDMs), and Geometric Deep Learning (GDLs). Each of these models can consume different data artifacts.

Most high-quality GenAI models require large computational resources (memory, storage, processing) to generate inferences. As a result, most queries are sent over the Internet to a service that operates in a Model-as-a-Service approach. This contrasts with the current tendency to protect data ownership. Many use-cases of GenAI cannot be simply solved by cloud services because not all data is suited to be sent over the Internet (e.g., intellectual property, sensitive documents).

Embodiments of the invention relate to generating inferences locally (e.g., on-premises) or in a local network. Embodiments of the invention are discussed with respect to a model and query server (MQS) for local area networks (LAN). However, embodiments of the invention may be adapted to other network configurations with locality features and a clustered topology of devices for storing and managing models.

AI PC faces various issues that are addressed or remedied by embodiments of the invention. Embodiments of the invention reduce or eliminate model duplication in a local context. When models are duplicated, this redundancy results in storage waste. Models may consume, for example, tens of gigabytes of storage and conserving storage may be particularly useful in devices (e.g., handheld devices such as tablets and smartphones) with limited storage and resources.

Embodiments of the invention also reduce high download wait times. In some instances, due to the size of these models, high download wait times may occur when an AI process running locally requires a specific deep learning computational model that is not locally available. In such cases, the device would need to retrieve the missing model from another source. If possible, the device may attempt to download the required model directly from a remote source over the Internet. This, however, may result in unacceptable wait times.

Embodiments of the invention address these concerns by providing a centralized download control. This reduces scenarios such as duplication where multiple clients download the same model. This advantageously reduces duplicate network traffic, conserves cost, and allows the same model to be shared among all devices connected to the same network (e.g., a local area network (LAN)). Further, a centralized download control can coordinate downloads with quota control.

In addition, a centralized download control for models, agents, and copilots can centralize and improve security and authentication concerns. A centralized download control also facilitates aspects of distributing copies of the model and model configurations to various clients. More specifically, a centralized point of configuration improves control and results in faster response times in case new configuration settings are required. For example, an administrator can patch a model’s vulnerability and the effects can be immediately dispatched to all the client devices that are impacted. The administrator, or control plane, m may keep a log that identifies the models that are installed at the clients. This is useful when new prompt attacks are discovered, and allows a centralized protection action to be performed quickly.

Embodiments of the invention bring the power of models closer to the source of the data or the demand. Embodiments of the invention may be implemented as, by way of example, only, a home server system, as middleware in an existing network attached storage system, as a server that is deployed to a business unit, campus, or the like.

Embodiments of the invention generally relate to a model and query system, which may include an MQS, that may be implemented closer to a source of the data or demand.

Embodiments of the invention include various assumptions about the models and environments. However, embodiments of the invention may be implemented even when these assumptions vary.

For example, LANs have high throughput, low latencies, and are more robust to setbacks and downtime compared to other networks such as cellular networks or the Internet. Advantageously, downloading a model, such as a large language model, from a local source (an MQS resident in the LAN) is much faster and more dependable than downloading from a remote source over the Internet.

GenAI models can be specialized. For example, model A may be trained in health-related topics while model B may be trained in general knowledge topics. GenAI models may also have overlapping usage patterns. For instance, two different users with different patterns of GenAI usage can query the same model in their activities. When GenAI models are used by a user, the usage often corresponds to a short interval of time. This allows temporal aspects of model usage to be leveraged by the model and the MQS.

Generally, users submit queries that are answered by one or more models. Queries are not required to be text, but may be in other forms/formats such as audio or image formats. Further, a query may include combinations of formats or forms. A query may combine an image with a question of “Where was this picture taken?”.

Queries are considered to be part of a workload, which also includes all tasks, information, and other requirements needed to generate an answer to the query. Workloads are typically generated when a query is originated or received. In some examples, the models of an MQS (or model and query system) may be associated with a budget. Thus, a policy may be in force that is based on or associated with one or more of licensing, storage, compute capability, carbon footprint, energy consumption, and so on.

Agents and copilots, which may assist in performing a workload, may themselves include or require multiple GenAI models (e.g., multimodal, GANs, etc.). Agents and copilots, in this context, are considered to be examples of models.

In one example, an MQS can hold or store auxiliary data and metadata to support the dynamic nature of the personalization for user or groups. The model may be predictable based on past queries, topics, or group/user behavior on the LAN.

Embodiments of the invention may be implemented as an as-a-Service and may operate in various modes. A model service (MS) mode serves models downloaded by network devices in response to, or in anticipation of, user requests. A model serving and workload solver (MSWS) mode allows a manager to both store models and use the models to solve workloads such as GenAI workloads. The MSWS mode is typically more demanding from a resource and administration perspective and may benefit from various accelerators such as GPUs (graphical processing units), NPUs (Neural Processing Unit), and the like.

An MQS configured to operate in multiple modes provides flexibility. The MQS, for instance, may decide when to share a model with a client and when to solve a query inside the server. A model, for example, may be too heavy (large) to be pushed to a particular client or may require a computationally demanding pipeline. Some devices may not have the resources to accommodate a model. In addition, large language models may have demanding pipelines for various reasons such as self-reflection, hallucination detection, and the like.

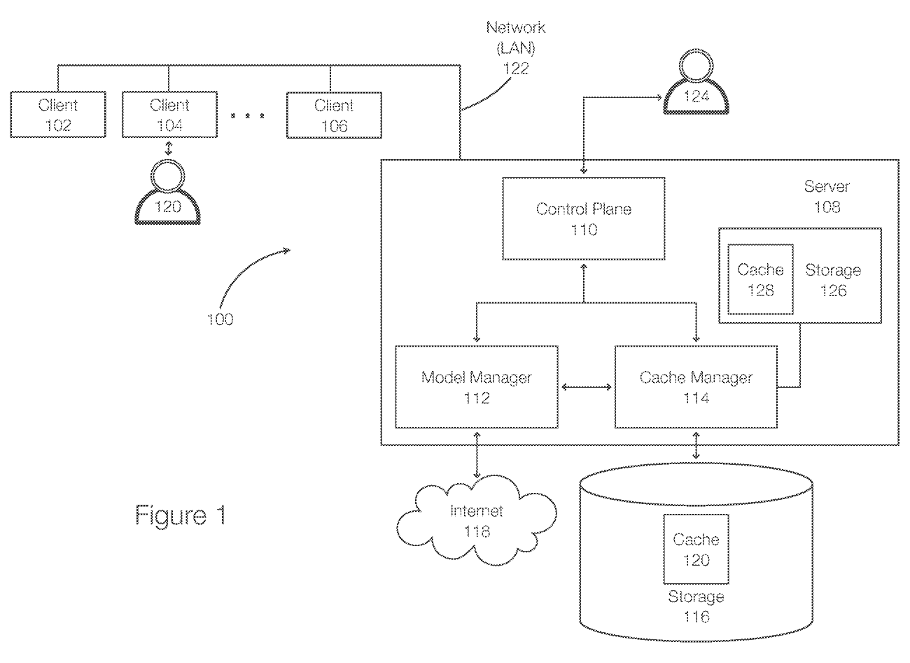

FIG. 1 discloses aspects of a model and query server in a computing environment. In this example, the environment 100 includes clients, represented by clients 102, 104, and 106 connected with a server 108 via a network (LAN) 122, which may employ various protocols/technologies such as IP, Ethernet, Wi-Fi 7, or the like. The server 108 is an example of an MQS and includes a control plane 110, a model manager 112, and a cache manager 114.

In this example, all devices (e.g., clients 102, 104, 106) have access to the server 108 and can request a model for local execution (MS mode) or send a workload to the server 108 for execution (MSWS mode). The clients 102, 104, 106 may include various form factors such as, but not limited to, AI PC notebooks or devices, handheld devices, wearable devices, computers, or the like. These devices are connected to the network 122.

The system 100 is an example of a local system that provides an environment in which queries can be generated and answered locally. Even if an external source is accessed to retrieve a model, inferencing and/or training operations are performed locally with respect to the network 122 and/or clients connected thereto.

Queries may be input via applications or via an interface. In addition, the clients 102, 104, 106 may also include a local agent that, if enabled by policy, may assist in downloading models, routing queries to the server 108, or the like. The agent may, if enabled by policy, collect usage history, collect telemetry data and share the usage history and telemetry data with the server 108. This may enable more accurate model recommendations for subsequent queries and/or for downloading models in a predictive manner.

The server 108 may be implemented as a software stack on a machine (e.g., server computer, cluster) on the network 122. Alternatively, the server 108 may be implemented on a physical or virtual machine as-a-service. As previously stated, the network 122 or LAN may provide low latency, high bandwidth, and high availability in addition to a gateway connection to the Internet 118.

Generally, the control plane 110 is configured for managing the model manager 112 and the cache manager 114. The control plane 110 may provide a user interface to an administrator 124. The administrator 124 may be human, an AI agent, or a hybrid.

The model manager 112 is configured for receiving a workload (or query) from the client 104 (which may be originated by or input by the user 120 in one example). After receiving the workload or query, the model manager 112 may execute the workload (e.g., if in MSWS mode), allocate computer resources (e.g., NPU, GPU), gather telemetry, and manage the active and stored or cached models. The model manager 112 may perform tasks including on-demand or predictive downloading of models from the Internet 118 or from a model catalog, alert local clients of new models that are available, push model updates to clients, and supervise model caching on the server 108 and on the clients 102, 104 and 106 in order to purge models that are no longer permitted or need to be removed/replaced/updated.

More specifically in one example, the model manager 112 is configured to interface with clients 102, 104, and 106. The model manager 112 has visibility into the models stored at the server 108 and their related information and is responsible for deploying, training, and management operations.

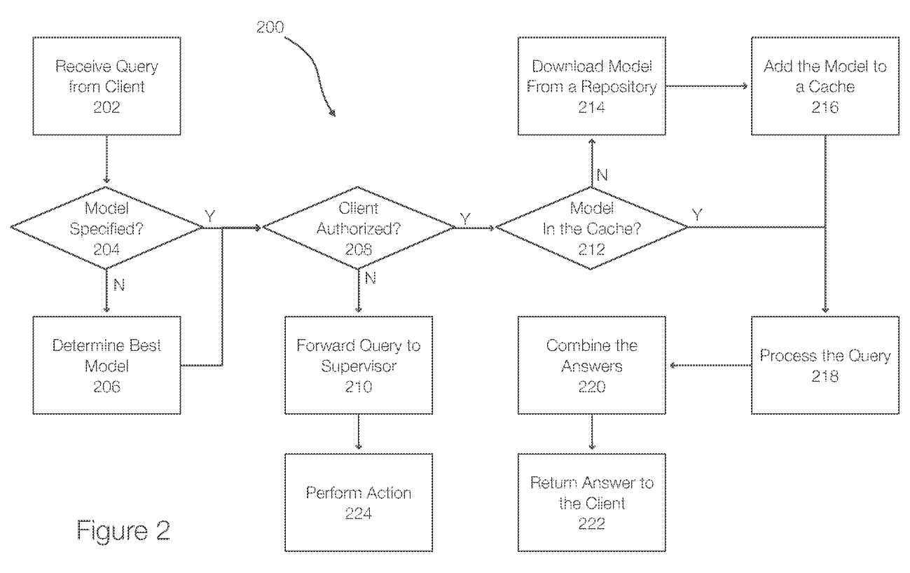

FIG. 2 discloses aspects of the model manager 112 operating in the MSWS mode. The method 200 includes receiving 202 a query from a client. The query may specify the model (e.g., specify the large language model (LLM) to execute the query), include client credentials, and/or the like.

If the query received from the client does not specify a model (N at 204) for the query, the best model for the query is determined 206. Determining 206 the best model may include the use of a semantic router that computes, using a GenAI system, the intent or topic of the query.

If the model is specified (Y at 204), the model manager 112 determines whether the client is authorized (e.g., using the credentials included in the query). If the client is not authorized (N at 208), the query is forwarded 210 to a supervisor (e.g., the administrator 124) for further handling. Usage rights may be determined using, by way of example, lightweight directory access protocol (LDAP).

If the client is authorized (Y at 208), the model manager 112 determines whether the requested model is present in a cache or otherwise stored at the server 108. A relational database may be used to identify models currently in cached in storage at the server 108. If the model is not present in the cache (N at 212) at the server 108, the model is downloaded 214 from a repository and added 216 to the cache. The repository from which the model is downloaded is typically accessed via the Internet or other external network. If the model is in the cache (Y at 212), the query is processed (answered) 218 at the server. If necessary, such as when the query is broken into multiple subqueries, the answers are combined 220. The final answer is returned 222 to the client.

If the client is not authorized (N at 208) the decision can be delegated or forwarded 210 to a supervisor such as the administrator 124. At this point of the method 200, the administrator may select and perform 224 an action. In an example without any human availability, one action is to return an error message or a failure message to the client. Reasons for failing or denying the query may include a lack of resources, a lack of rights, or the like. Alternatively, the administrator, which may be human, an agent, or hybrid, may be able to authorize or deny the query.

In one example, a query quota control and a download quota control may be implemented by the model manager 112. These quota controls may include a use or a user-based control, a system-wide control, or both. A system-wide control would ensure that, in the aggregate, model downloads from external networks or subscription services are within a certain limit of bandwidth or budget. This can be extended to facilitate other features such as license control and security version control.

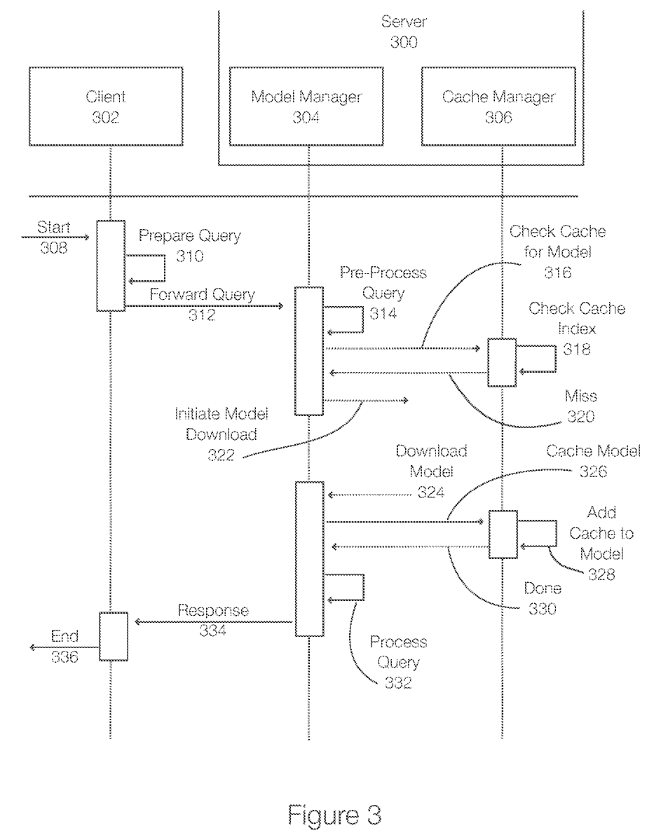

FIG. 3 discloses aspects of a method for orchestrating a query locally, such as within a LAN or on-premise. FIG. 3 illustrates a server 300 (e.g., an MQS) connected with a client 302 over a network such as a LAN. The server 300 is an example of the server 108 and includes a model manager 304 and a cache manager 306. The method 300 further illustrates examples of communications or interactions between the client 302, the model manager 304, and the cache manager 306.

In one example, the model manager 304 may be configured to download and cache models with the cache manager 306 during the execution of a workload. In this example, a client may start 308 this process. The client may prepare 310 a query is prepared and forward 312 the query to the model manager 304. The query is processed 314 by the model manager 304. Processing 314 the query received from the client 302 may include determining the best model for the query, assessing whether the client 302 (or user) is authorized for the required/requested model, and the like. If processing is successful, the model manager 304 checks 316 the cache maintained by the cache manager 306. The cache manager 306 checks 318 the cache index and returns a hit or miss. In this example, the model is not present in the cache and a miss is returned 320 to the model manager 304.

In response to the miss 320, the model manager 304 downloads 322 the model from an external source (e.g., the Internet). Once the model is downloaded 324, the model manager 304 requests that the model be cached 326 by the cache manager 306. The cache manager 306 then adds 328 the model to the cache.

The model retrieved from the Internet may be maintained at the model manager 304 such that the query can be processed or answered. Thus, the query from the client 302 is processed 332 (at the server 300 in this example) using the model and a response or answer to the query is sent to the client. The client 302 receives 334 the response and the process of FIG. 3 ends 336.

FIG. 3 illustrates that the model 300 is operating in the MSWS mode. In the MS mode, the server 300, after acquiring the model from the Internet 320, pushes the model to the client 302. The query is then processed locally at the client 302 to generate an answer to the query.

In one example, fine-grained control can be implemented in the model manager 304 using policy-defined budgets. Budgets can be applied in a situation in which the system accesses the models from a paid store with custom-built or general pre-trained models. This ensures improved better financial control.

In one example, the model manager 304 has semantic, model content, and model lifecycle management awareness. The model manager 304 monitors, or subscribes to be notified of updates to the model attributes (e.g., version, license, removal, architecture, size) and automatically takes appropriate actions (e.g., download update, purge from cache, seek alternative) according to policy on the server 300. The model manager 304 is also configured to notify all local devices (clients) that have copies of models that there is an update to their models or orchestrate to actively revoke the existing models and/or push a replacement model to the client. This awareness of the model manager 304 allows a version control scheme that supports partial functionality and feature upgrades for models to be implemented.

Because the model manager 304 has semantic and model capability awareness, the model manager 304 may be configured to recognize or understand the models that are cached and recommend other types of models to address incoming queries with the same or similar semantic meanings. The ability to recommend other types of models offers clients flexibility and the ability to optimize answers. For example, based on past observations, one available type of model may provide a better response to a newly arrived query than is expected from the previously downloaded type. The recommendation from the model manager 304 could improve the customer experience and aid in achieving improved answers.

In another example, by using one or more predictive AI model-based agents, the model manager 304 can anticipate interest in or need for specific models among the local clients and initiate downloads of those models to the server 300 to pre-stage them in the MQS cache for projected or anticipated needs of local clients.

Returning to FIG. 1, the cache manager 114 is configured for managing a cache 128 implemented on storage 126 (e.g., server-based storage, disk drives, NVMe) and, when available, a cache 120 implemented on storage 116 (e.g., server-attached external storage system). In one example, the storage 126 and 116 may each be exposed as a file system or object store to the cache manger 114 and include non-volatile storage devices. The cache manager 114 may control the server-attached devices, the storage protection, the logical storage abstraction, the cache structure, and the storing, retrieving, and deletion of models as directed by the model manager 112. The cache manager 114 may also perform content-aware data reductions (e.g., model deduplication, model compression (lossless, lossy)) as permitted by policy.

The cache manager 114, in one example, is a peer to the model manager 112 in the server 108 and is configured to manage and operate the cache (128 and/or 120) of models implemented on storage 126 and/or storage 116, although the model manager 112 may control or determine which models are stored in the cache (128 and/or 120). The cache manager 114 is responsible for interfacing with the physical and logical storage (e.g., NVMe) that are dedicated to the caching function.

The cache manager 114 may be configured to perform various cache-related operations as requested by the model manager 112 and/or by policy set by the model manager 112 and/or the administrator 124 via the control plane 110.

Examples of operations performed by the cache manager 114 (e.g., in response to a request or instruction from the model manager 112) include, but are not limited to: storing a model in the cache (120 and/or 128) and updating a metadata structure accordingly; responding to a cache query from the model manager 112 regarding the presence of a model in the cache (120 and/or 128; updating and/or retrieving metadata associated with a cached model; replacing a cached model with another model (e.g., a different model, an updated model); retrieving a cached model and loading the retrieved model into a memory buffer for use by the model manager 112; evicting and erasing a cached model on-demand or automatically in accordance with policy and/or access history (e.g., a least recently used list); pinning/unpinning a model stored in the cache to prevent/facilitate eviction of the model from the cache; and moving models to different cache storage tiers, if available, based on recent access history, policy, and/or response to a pin operation.

A multiple tiered cache allows the server 108 to deliver faster answers/pushes as more frequently used models can be stored in faster tiers while less frequently used models can be stored in a slower but cheaper tier of storage (e.g., cold storage, HDDs).

In another embodiment, the cache manager 114 may coordinate with another cache manager in a peer model and query server, for example, to make eviction decisions (e.g., a peer may have a copy so the model can be evicted), extend retrieval requests to a peer model and query server before declaring a cache miss (if allowed by policy), or expand cache storage space to use the cache of a peer model and query server as a lower tier of cache/storage.

In another example, at the direction of the model manager 112 or the administrator 124, an automatic model storage policy may be defined. For example, a model that was used by a single client only once (shared intelligence from model manager 112 via attribute updates) may be removed to save space when a certain storage threshold is achieved. A server 108 can have as many automatic policies as needed and these policies or decisions are visible to the cache manager 114 in one example.

In addition to an automatic policy, the cache manager 114 may also have the option to allow the system administrator 124 to perform actions that override one or more policies. For example, the administrator 124 may block a model from being retrieved, but not removed, or the administrator 124 may configure the cache manager 114 to ask for credentials to use a set of models.

The cache manager 114 (and/or the model manager 112) are configured such that the administrator 124 can have access thereto via a web browser interface (e.g., a web-based management interface).

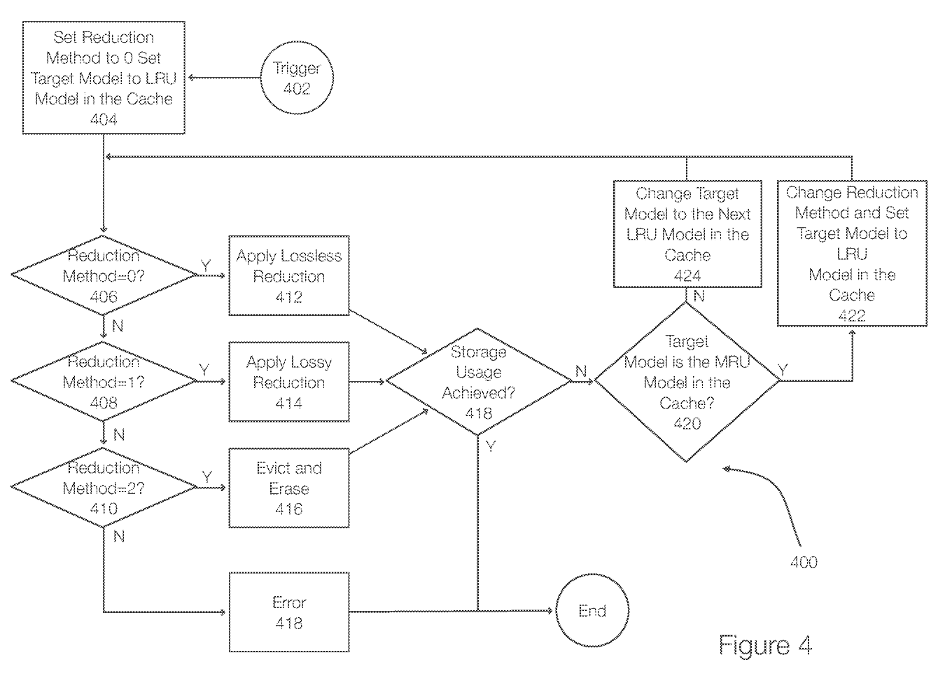

FIG. 4 discloses aspects of policy-driven operations or actions performed by a cache manager. In this example, the policy relates to cache storage utilization. A high water mark (HWM), such as “90% used” and a low water mark (LWM), such as 75% used” may be defined. FIG. 4 illustrates a method (e.g., an event handler) that may execute when a certain threshold is achieved (e.g., the high water mark). This event handler can, if policy allows, support both lossless and lossy content-aware data reduction techniques to reduce storage used prior to resorting to model evictions.

The method 400 includes receiving a trigger 402 (or detecting a cache condition set by policy). In this example, the trigger may be that the cache has reached a HWM of 90% full (or other predetermined value). This triggers a method 400 to reduce the storage occupied by models stored in the cache. In one example, a reduction method is first chosen to indicate lossless reduction method and a target model is identified as the least recently used (LRU) model in the cache 404.

As illustrated in the method 400, the reduction method may change during operation of the method 400 from least impactful on cache model availability and fidelity to most impactful. In this example, three reduction methods are considered: lossless reduction (0), lossy reduction (1), and eviction (2). Initially, the reduction method is set to (0) or lossless reduction. In this example, the target model may be the LRU model in the cache. The target model is processed in a manner that attempts to reduce the amount of storage used without evicting the model. The model is only evicted and erased, in this example, when other reduction methods do not achieve the desired or specified reduction in used cache storage (i.e., at or below LWM). The method 400 may perform one or more reduction methods on one or more target models until the used storage reaches a LWM (e.g., 75% full).

When the method 400 begins, the reduction method is set (e.g., to 0) and the target model is identified 404 as the LRU model in the cache. In this example, the initial reduction method is lossless (Y at 406) and lossless reduction is applied 412 to the target model. After applying the lossless reduction, the method 400 determines whether the desired storage usage is achieved (i.e., storage usage is at or below the LWM). If the storage usage is achieved (Y at 418), the method ends. If the storage usage is not achieved (N at 418), the method determines whether the target model is the most recently used (MRU) model in the cache. In the case of the target model not being the MRU model in the cache (N at 420), the target model is updated to be the next LRU model in the cache 424 and the lossless reduction method (Y at 406) is applied 412 to the new target model. In the case of the target model being the MRU model in the cache (Y at 420), it is because lossless reduction has been applied to all models in the cache. Thus, the reduction method is incremented 422 to (1) and the target model is again set to the LRU model 422 in the cache.

In this example, the method loops and reaches the decision point 408 because the reduction method is now (1) (N at 406 and Y at 408). Thus, lossy reduction is applied 414 to the target model. If the storage usage LWM is not achieved (N at 418) and there are more models in the cache (N at 420) against which to apply lossy reduction, the target model is again updated 424 to be the next LRU model in the cache and the lossy reduction method will continue (N at 406 and Y at 408) to be applied to each of the remaining models in the cache until the storage usage LWM is achieved 418 or the MRU model is reached (Y at 420) and the reduction method is then incremented to (2) 422.

In the next iteration of the loop, because the reduction method is evict (2), the method reaches the decision point 410 (N at 406, N at 408, Y at 410). As a result, eviction and erasure is applied 416. If the storage usage LWM is still not achieved (N at 418) and there are more models in the cache (N at 420) that have not been evicted, the target model is updated 424 to be the new LRU model in the cache (the previous LRU model was evicted) and the eviction method will continue (N at 406, N at 408, Y at 410) to be applied to each of the remaining models in the cache until the storage usage LWM is achieved 418 or the MRU model is reached (Y at 420) (i.e., all models have been evicted) and the reduction method is then incremented to (3) 422, which will result (N at 406, N at 408, N at 410) in an error being reported 426 and the method 400 ending.

The method 400 may be performed differently. For example, when the HWM is reached or triggered, the models in the cache may be sorted by another characteristic (e.g., number of times a model is utilized or by a learned quality ranking) in a stack. Models are addressed with the same reduction method from least utilized or lowest quality ranking (or combination of the two) to the highest until the LWM is achieved or the next reduction method is chosen and the ordered traversal of the cached models repeats. Once the LWM is achieved the method 400 stops. In another example, only the eviction method is implemented (or enabled by policy). This is applied to each cached model in increasing utilization or ranking order until the low water mark is achieved. In another example, all implemented (or enabled by policy) reduction methods are applied to each model at a time before moving on to the next model in the list.

In another example, the method 400 may be adapted such that the reduction methods are applied in succession to the same LRU model and the storage usage is evaluated after each reduction method. If this does not achieve the LWM, the reduction methods are applied to the next LRU model in the cache. This continues until the LWM is achieved. This may allow the LRU models to be modified/evicted without impacting or applying reduction methods more recently used models in the cache.

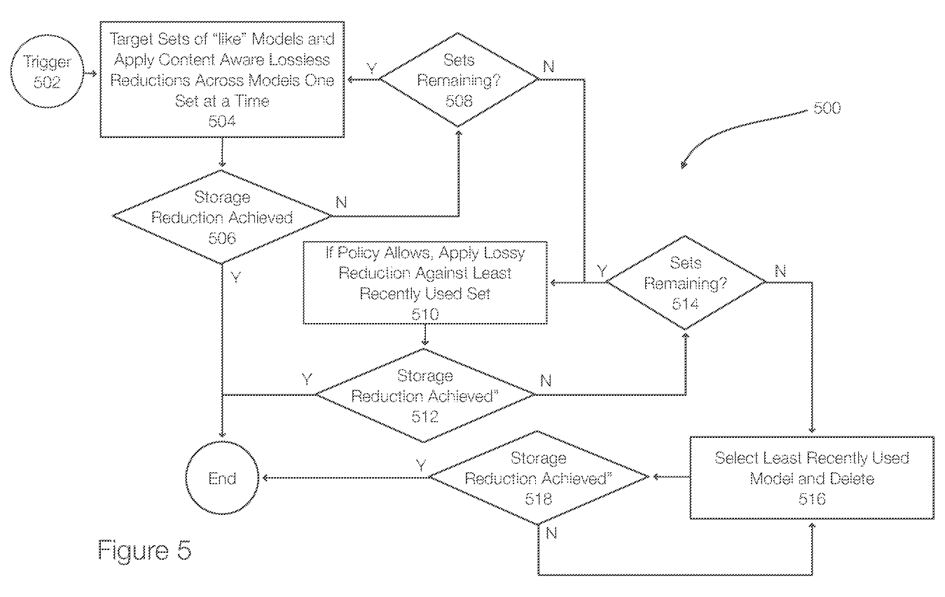

FIG. 5 discloses additional aspects of cache management performed by a cache manager in an MQS. The method 500 includes receiving 502 a trigger or otherwise detecting a condition of the cache such as HWM reached. The method 500 is similar to the method 400, but references sets of similar models. Further, the policies described in FIG. 5 may be applied to the method 400.

In this example, a set of similar models is identified 502. The set of similar models may include a least recently used (LRU) model or, in the aggregate, the set of similar models is the LRU set of models. The method 500 may be applied to all models in the set as a whole. Alternatively, the models in a particular set may be processed one at a time and the impact on the storage reduction is determined.

Initially, lossless reduction is applied to the selected set of models (or to the models in the set one at a time). If the storage reduction is achieved (Y at 506) (e.g., storage is at or below the LWM threshold), the method 500 ends. Otherwise, the next set is selected if sets are remaining (Y at 508). If no sets are remaining (N at 508) and if policy allows, lossy reduction is applied 510 to the LRU set of models. If storage reduction is achieved (Y at 512), the method ends. If storage reduction is not achieved (N at 512) and sets are remaining (Y at 514), lossy reduction is applied to the next set.

If no sets remain (N at 514), the LRU model is selected and deleted 516 from the cache. This is repeated (516) until storage reduction is achieved (Y at 518).

In some embodiments, triggers may relate to time periods (e.g., “daily at night)” or when a security update is available. A policy may include a storage budget, for instance, in a case where the storage capacity is not an issue, just the cost of storing.

As previously discussed, an MQS may operate in various modes. In one mode (MS mode), the model is pushed to the client and in another mode (MSWS) the execution occurs at the server. In another example, a hybrid approach is performed in which only parts of the model are pushed to the client.

In one example, a split architecture is employed such that only a portion of the model is pushed to the client. This allows a requesting client to infer locally and is less demanding than sending the full model. In another example, a light-weight form of a prompt generator is sent to the client device. This allows clients such as handheld devices to generate personal queries while consuming less network resources and fewer computational resources.

### EXAMPLE

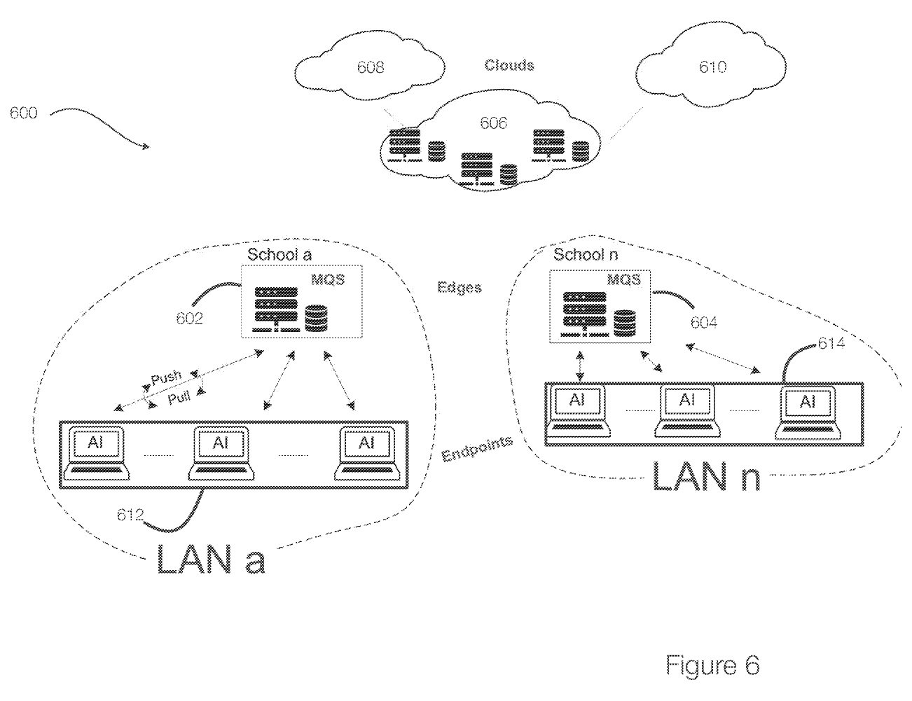

FIG. 6 discloses aspects of model and query servers operating in localized networks individually and/or in a peer relationship. The MQS instances, by way of example, are deployed to computing systems or environments, such as local area networks, for applications including, but not limited to, local inferencing and/or training operations. The environment 600 is an example of a group of connected schools (and connected LANs). Each of the schools hosts one or more physical/virtual servers with additional storage attached/allocated when needed. Each school has a local area network (LAN), or two adjacent schools can share a LAN. Each school (or subset of schools) includes at least one MQS per LAN. In this example, the LAN “a” of school “a” is associated with a server 602 and the LAN “n” of school “n” is associated with a server 604. The LANs “a” to “n” may have access to clouds or remote sources, represented by clouds 606, 608, 610.

In this example, each MQS may support hundreds to thousands of student notebooks (represented by clients 612 in LAN “a” and clients 614 in LAN “n”). The model manager of the server 602 may have visibility into a database that may store information such as AI model types, versions, security measures, deployed licenses, and storage usage, which may be logged for each of the clients in the corresponding LAN or system.

For common pre-trained large language models that can answer daily questions from students on science, math, literature or school process, class schedule, or the like, the model manager deploys (pushes) the large language models to the clients such that the students can benefit from GenAI on device to increase learning efficiency. For example, the model manager of the server 602 may push these types of models to the devices 612.

The server 602 may manage version updates, security, and privacy holistically. When a student (or client) requests a specific model (pulling a model from the server 602) or queries knowledge outside of the pre-trained model’s capability, the model manager and the cache manager work together to pick the suitable model.

In this case, the query can be processed in the server 602 (MWSW mode) or the chosen model can be pushed from a storage pool (a cache) to the requesting client after checking policy such as license availability and client’s resource availability, or the like. The server 602 may alternatively retrain common models using hardware resources of the school in this example (or using resources from multiple schools. The model manager ensures that when models are downloaded from the cloud 606, the model manager only downloads from reputable sources. The model manager is also responsible for pushing feature updates or security updates to the clients 612.

This LAN-centric architecture provides various benefits and advantages. In one example, the model manager of the server 602 may ensure that the knowledge from the cloud 606 is reputable, age appropriate, and/or not sourced from deceptive news or suspected sources of increased security and privacy threats (e.g., ransomware). This results in a safer environment compared to a scenario where the students are downloading directly from the cloud. This also results in conserving or saving computing resources of the school. For example, regularly fixing hundreds of clients that are exhibiting different symptoms from having downloaded models with malware, or having collected unnecessary models that consume too much of the available resources such that the daily school activities of the students is negatively impacted, can be avoided.

For models that require a license or involve monetary transactions (e.g. payments, group discounts), the model manager of the server 602, with the assistance of the control plane, can monitor model usage and can automate the registrations or monetary transactions. To cope with limited budget, the server 602 can move licenses from inactive users to active users based on needs or priority, achieving cost savings for the school and students.

When student model usage is monitored, the model manager can securely analyze this collected telemetry data locally to make predictions on future model needs by students and automatically download the models and have the cache manager pre-stage the models in the cache in anticipation of their future utility. This predictive download may be policy-directed to occur after normal school hours to prevent impacting network throughput during school.

When model storage utilization in the server 602 hits a high threshold (e.g., 90% full), the cache manager can utilize various model content-aware compression and deduplication techniques to relieve the storage pressure. If that is not sufficient to meet the preferred steady state storage utilization threshold (e.g., 75% full), the oldest models or least used models, or least recently used models will be removed to achieve that cache usage goal or requirements.

The model pool (e.g., models stored in the cache on server-based and/or server-attached storage) associated with the server 602 can be shared with all schools in adjacent LANs to avoid duplicate model downloads from the cloud, yielding less cyber risk while saving energy.

MSWS in the server 602 avoids duplicated model retraining on similar knowledge on clients 612. Retraining at the school level can be used for hundreds of users or clients 612, which saves compute and energy.

Embodiments of the invention include a LAN-centric storage and managing solution to keep LLMs or any other GenAI models such as Deep Neural Networks (DNN), Generative Adversarial Networks (GANs), and the like or combinations thereof, locally within the LAN.

This reduces waiting times to download models by storing them on a server located in the same LAN as local devices (clients) that have requested models, or are predicted to request models.

The MQS centrally coordinates model downloads to minimize network bandwidth consumption and removes unnecessary costs using a quota control when necessary.

An MQS that maintains or has access to a central pool of models to serve a specific LAN not only reduces download latency, but also reduces unnecessary and uncoordinated cloud requests by clients in the LAN. The model manager of the model and query server has semantic and model content awareness, which enables the model manager to implement a version control scheme that support at least partial functionality and feature upgrades for the models in the pool.

A model manager with semantic and model capabilities awareness may also be able to recognize which of the cached models can be recommended for incoming queries with the same or similar semantic meaning.

A cache manager with model content awareness can perform content-aware data reduction techniques (e.g., model deduplication, model compression) to optimize the cache storage capacity.

A model manager with model lifecycle management knowledge actively monitors, or subscribes to be notified of updates to, the model attributes (e.g., version, license, removal, architecture, size) in external upstream repositories and automatically takes appropriate actions (e.g., download updates, purge from cache, seek alternatives) according to policy on the local server. The model and query server can also notify all local clients that have copies that there is an update or orchestrate to actively revoke the rights to and delete the existing model or push a replacement model.

Embodiments of the model manager provide a model management service to devices on the LAN, and allow each device on the LAN to download necessary models and execute on the device. Users can safely delete downloaded models to release device storage space and come back to the pool if the model is needed again (at that time, the model is likely to be the latest version).

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, model orchestration including localized orchestration operations, model-based cache management operations, localized inference/training operations, localized model deployment operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter, an edge system, an on-premise system, or the like, which is operable to perform operations initiated by one or more clients or other elements of the operating environment.

Example cloud computing environments, which may or may not be public, include storage environments that may provide functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Multimedia objects and other unstructured data may be examples of objects.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. In a local area network that includes an model and query server (MQS) that includes a model manager and a cache manager, a method comprising: receiving a query from a client connected to the local area network at the model manager, wherein the cache manager manages a cache at the MQS and wherein the cache is configured to store models, determining a model for answering the query, and generating an answer to the query using the model without sending the query outside of the local area network, wherein the answer is provided to the client.

Embodiment 2. The method of embodiment 1, further comprising determining whether the model is present in the cache.

Embodiment 3. The method of embodiment 1 and/or 2, wherein the query identifies the model or wherein the model manager determines the model based on an intent or topic of the query.

Embodiment 4. The method of embodiment 1, 2, and/or 3, further comprising acquiring the model from an external source when the model is not present in the cache and storing the acquired model in the cache.

Embodiment 5. The method of embodiment 1, 2, 3, and/or 4, further determining a mode associated with the query.

Embodiment 6. The method of embodiment 1, 2, 3, 4, and/or 5, further comprising pushing the model to the client when operating the MQS in a first mode such that the answer is inferred at the client or executing the model when operating the MQS in a second mode such that the answer is generated at the MQS using the model.

Embodiment 7. The method of embodiment 1, 2, 3, 4, 5, and/or 6, further comprising determining that the client is authorized to access the model.

Embodiment 8. The method of embodiment 1, 2, 3, 4, 5, 6, and/or 7, further comprising managing the cache in response to a trigger, wherein managing the cache includes one or more of reducing a size of at least one model stored in the cache in a lossless manner, in a lossy manner, and/or by eviction from the cache.

Embodiment 9. The method of embodiment 1, 2, 3, 4, 5, 6, 7, and/or 8, wherein the model manager has semantic and model capabilities awareness and is configured to recommend other models to address the query, and wherein the model manager is configured to perform model lifecycle management.

Embodiment 10. The method of embodiment 1, 2, 3, 4, 5, 6, 7, 8, and/or 9, further comprising storing models in the cache in a predictive manner based on telemetry collected relative to model usage by clients in the local area network.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, manager, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

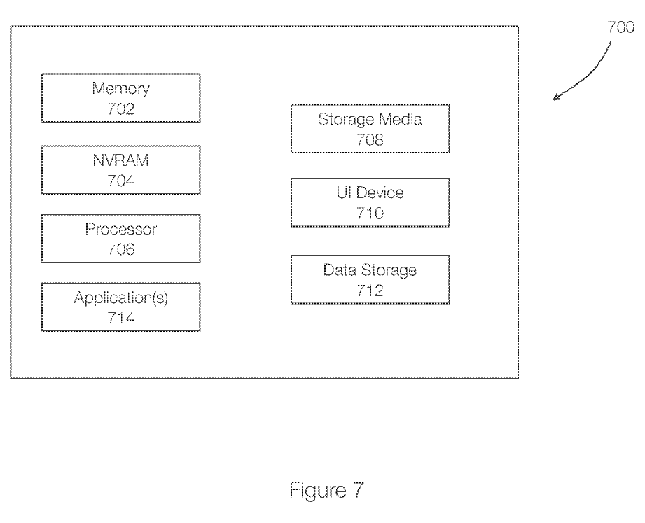

With reference briefly now to FIG. 7, any one or more of the entities disclosed, or implied, by the Figures and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

The device 700 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 700 may also represent a physical or virtual machine or server, an edge-based computing system, a cloud-based computing system, server clusters or other computing systems or environments. The device 700 may also represent multiple machines or devices, whether virtual, containerized, or physical. The device 700 may perform or execute steps or acts of the methods/operations illustrated in the Figures and described herein.

The device 700 may represent a cloud-based system, an edge-based, system, an on-premise system, or combinations thereof. Document understanding and related operations may be performed using these types of computing environments/systems. The device 700 may also represent a model and query server and/or system.

The described embodiments are to be considered in all respects only as illustrative and not restrictive. All changes which come within the meaning and range of equivalency of the claims are to be embraced within their scope.

What is claimed is:

1. In a local area network that includes a model and query server (MQS) that includes a model manager and a cache manager, a method comprising:
receiving a query from a client connected to the local area network at the model manager, wherein the cache manager manages a cache at the MQS and wherein the cache is configured to store models;
determining a model for answering the query; and
generating an answer to the query using the model without sending the query outside of the local area network, wherein the answer is provided to the client.

2. The method of claim 1, further comprising determining whether the model is present in the cache.

3. The method of claim 1, wherein the query identifies the model or wherein the model manager determines the model based on an intent or topic of the query.

4. The method of claim 2, further comprising acquiring the model from an external source when the model is not present in the cache and storing the acquired model in the cache.

5. The method of claim 2, further determining a mode associated with the query.

6. The method of claim 5, further comprising pushing the model to the client when operating the MQS in a first mode such that the answer is inferred at the client or executing the model when operating the MQS in a second mode such that the answer is generated at the MQS using the model.

7. The method of claim 1, further comprising determining that the client is authorized to access the model.

8. The method of claim 1, further comprising managing the cache in response to a trigger, wherein managing the cache includes one or more of reducing a size of at least one model stored in the cache in a lossless manner, in a lossy manner, and/or by eviction from the cache.

9. The method of claim 1, wherein the model manager has semantic and model capabilities awareness and is configured to recommend other models to address the query, and wherein the model manager is configured to perform model lifecycle management.

10. The method of claim 1, further comprising storing models in the cache in a predictive manner based on telemetry collected relative to model usage by clients in the local area network.

11. A non-transitory storage medium having stored therein instructions that are executable by one or more hardware processors to perform operations in a local area network that includes a model and query server (MQS) that includes a model manager and a cache manager, the operations comprising:
receiving a query from a client connected to the local area network at the model manager, wherein the cache manager manages a cache at the MQS and wherein the cache is configured to store models;
determining a model for answering the query; and
generating an answer to the query using the model without sending the query outside of the local area network, wherein the answer is provided to the client.

12. The non-transitory storage medium of claim 11, further comprising determining whether the model is present in the cache.

13. The non-transitory storage medium of claim 11, wherein the query identifies the model or wherein the model manager determines the model based on an intent or topic of the query.

14. The non-transitory storage medium of claim 12, further comprising acquiring the model from an external source when the model is not present in the cache and storing the acquired model in the cache.

15. The non-transitory storage medium of claim 12, further determining a mode associated with the query.

16. The non-transitory storage medium of claim 15, further comprising pushing the model to the client when operating the MQS in a first mode such that the answer is inferred at the client or executing the model when operating the MQS in a second mode such that the answer is generated at the MQS using the model.

17. The non-transitory storage medium of claim 11, further comprising determining that the client is authorized to access the model.

18. The non-transitory storage medium of claim 11, further comprising managing the cache in response to a trigger, wherein managing the cache includes one or more of reducing a size of at least one model stored in the cache in a lossless manner, in a lossy manner, and or by eviction from the cache.

19. The non-transitory storage medium of claim 11, wherein the model manager has semantic and model capabilities awareness and is configured to recommend other models to address the query, and wherein the model manager is configured to perform model lifecycle management.

20. The non-transitory storage medium of claim 11, further comprising storing models in the cache in a predictive manner based on telemetry collected relative to model usage by clients in the local area network.
